(19) United States
(12) Patent Application Publication
(10) Pub. No.: US 2005/0041411 A1
(43) Pub. Date: Feb. 24, 2005

(54) [BACK LIGHT MODULE]

(76) Inventor: CHIH-KANG WU, TAOYUAN (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/708,803

(22) Filed: Mar. 26, 2004

(30) Foreign Application Priority Data
Aug. 20, 2003 (TW) 92122812

(51) Int. Cl. F21V 7/04

(52) U.S. Cl. 362/31

(57) ABSTRACT

A back light module comprising a frame, a reflective plate, at least a light source, a caved transparent plate, a diffusion plate and several optical films is provided. The reflective plate is set up at a bottom section of the frame and the light source is set up within the fame above the reflective plate. The caved transparent plate is set up over the frame above the light source. The diffusion plate is set up over the caved transparent plate such that a gap is formed between diffusion plate and the caved transparent plate. The optical films are set up over the diffusion plate. With the caved transparent plate disposed inside the back light module, heat is prevented from passing from the back light module into a liquid crystal display panel.

### CROSS REFERENCE TO RELATED APPLICATIONS

This application claims the priority benefit of Taiwan application serial no. 92122812, filed on Aug. 20, 2003.

### BACKGROUND OF INVENTION

1. Field of the Invention

The present invention relates to a back light module. More particularly, the present invention relates to a back light module with a design that prevents heat from a light source from conducting to an overlying liquid crystal display panel.

2. Description of the Related Art

To match the lifestyle of modern people, size and weight of most video and imaging products are reduced. Although the conventional cathode ray tube (CRT) display had many advantages and was popular for some time, bulkiness and potential radiation hazards are two major factors that speed the gradual changeover to flat panel displays. With rapid progress in semiconductor fabrication technologies, flat panel displays including liquid crystal displays (LCD), organic light-emitting display (OLED) and plasma display panel (PDP) has become the mainstream display products.

In general, liquid crystal displays can be classified into reflective LCD, transmissive LCD and transflective LCD according to their light source. Using a transmissive or transflective LCD as an example, the LCD mainly comprises a liquid crystal panel and a back light module. The liquid crystal panel has a structure comprising a liquid crystal layer sandwiched between a pair of transparent substrates. The back light module illuminates the liquid crystal panel with a planar light source so that data can be clearly seen on the liquid crystal display screen.

FIG. 1 is a schematic cross-sectional view of a conventional back light module. As shown in FIG. 1, the back light module 100 mainly comprises a frame 102, a reflective plate 104, at least a light source 106, a diffusion plate 108, several optical films 110 and at least a support element 112. The reflective plate 104 is positioned at the bottom section of the frame 102. The light sources 106 are set up within the frame 102 above the reflective plate 104. The diffusion plate 108 is set up on the frame 102 above the light sources 106. The optical films 110 are set up over the diffusion plate 108. The support elements 112 are set up between the reflective plate 104 and the diffusion plate 108. In addition, a liquid crystal panel (not shown) must be positioned over the back light module 100 to form a fully functional liquid crystal display.

Obviously, the liquid crystal display is illuminated by a planar light source emitted from the back light module after passing through various film layers. However, aside from producing light, the light source inside the back light module also produces heat. When the heat dissipates via the diffusion film on the back light module into the overlying liquid crystal panel, display quality of the liquid crystal display panel is likely affected. Because the transfer of heat to the liquid crystal panel from the light source is unlikely to be uniform, the liquid crystal layer within the liquid crystal panel is subjected to different degrees of heating. Aside from affecting the liquid crystal molecules inside the display, the non-uniform distribution of heat also affects the switching of thin film transistors inside the liquid crystal display. Ultimately, the overall display quality of the liquid crystal panel deteriorates.

### SUMMARY OF INVENTION

Accordingly, at least one object of the present invention is to provide a back light module capable of limiting the amount of heat generated by a light source from passing into a liquid crystal panel and resulting in a non-uniform display.

At least a second object of this invention is to provide a back light module capable of reducing the effect of heat generated by a light source from affecting the operation of thin film transistors and the liquid crystal molecules inside a liquid crystal panel.

To achieve these and other advantages and in accordance with the purpose of the invention, as embodied and broadly described herein, the invention provides a back light module design. The back light module comprises a frame, a reflective plate, a light source, a caved transparent plate, a diffusion plate and an optical film. The reflective plate is set up at the bottom section of the frame. The light source is set up within the frame above the reflective plate. The caved transparent plate is set up over the frame above the light source. The caved transparent plate is fabricated using a transparent material such as acrylic. The diffusion plate is set up over the caved transparent plate such that a gap is formed between the diffusion plate and the caved transparent plate. The optical film is set up over the diffusion plate.

This invention also provides an alternative back light module design. The back light module comprises a frame, a reflective plate, a diffusion plate, a caved transparent plate and an optical film. The reflective plate is set up at a bottom section of the frame. The light source is set up within the frame above the reflective plate. The diffusion plate is set up over the frame above the light source. The caved transparent plate is set up over the diffusion plate such that a gap is formed between the caved transparent plate and the diffusion plate. The caved transparent plate is fabricated from a material such as acrylic. The optical film is set up over the caved transparent plate.

In this invention, an additional caved transparent plate is set up inside the back light module. Through the gap between the caved transparent plate and the diffusion plate, thermal conduction is retarded so that the amount of heat transferring to the liquid crystal panel is immensely reduced. Consequently, a liquid crystal panel having a uniform display is produced.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic cross-sectional view of a conventional back light module.

FIG. 2A is a schematic cross-sectional view of a back light module according to a first preferred embodiment of this invention.

FIG. 2B is a magnified view of the diffusion plate and the caved transparent plate in the back light module shown in FIG. 2A.

FIG. 3A is a schematic cross-sectional view of a back light module according to a second preferred embodiment of this invention.

FIG. 3B is a magnified view of the diffusion plate and the caved transparent plate in the back light module shown in FIG. 3A.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

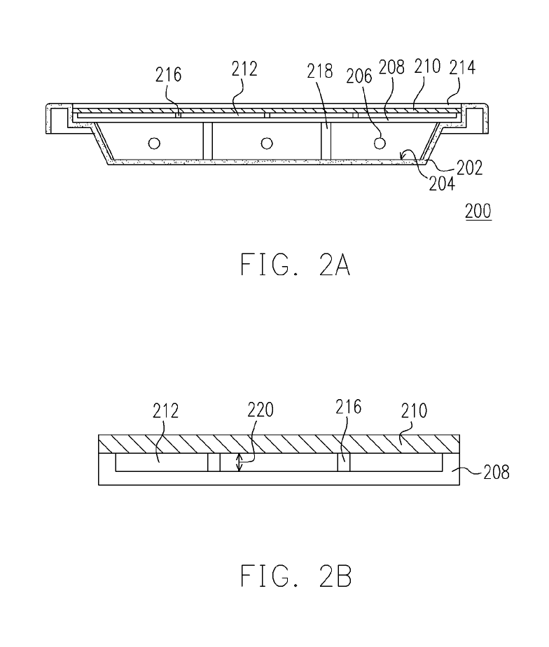

FIG. 2A is a schematic cross-sectional view of a back light module according to a first preferred embodiment of this invention. FIG. 2B is a magnified view of the diffusion plate and the caved transparent plate in the back light module shown in FIG. 2A. As shown in FIGS. 2A and 2B, the back light module 200 comprises a frame 202, a reflective plate 204, at least a light source 206, a caved transparent plate 208, a diffusion plate 210 and several optical films 214.

The reflective plate 204 is set up at a bottom section of the frame 202. The reflective plate 204 mainly serves as a reflective surface for deflecting light heading away from a display panel (not shown) so that utilization efficiency of the light source 206 is increased. Furthermore, the reflective plate 204 is formed, for example, by roughening the inner surface of a white-coated plate or a resinous plate and then performing a surface treatment with aluminum to increase the reflectivity of light.

The light source 206 is set up within the frame 202 above the reflective plate 204. The light source 206 is a lamp tube, a light bulb, a light-emitting diode array or a fluorescent lamp, for example. Furthermore, the fluorescent lamp is a straight tube, a U-shaped tube or a flat fluorescent light source. The light source 206 is positioned inside the frame 202 through support posts (not shown), for example.

The caved transparent plate 208 is set up over the frame 202 above the light source 206. The caved transparent plate 208 is fabricated using a transparent material such as acrylic. In general, the caved transparent plate 208 must be fabricated using a material having properties including a high transparency, low deformation, and low moisture absorption.

The diffusion plate 210 is set up over the caved transparent plate 208 such that a gap 212 is formed between the diffusion plate 210 and the caved transparent plate 208. The gap 212 has a vertical height 220 between 2 to 5 millimeters and the space within the gap is air-filled, for example. The air inside the spatial gap serves as an insulator blocking the transfer of heat across the gap. The diffusion plate 210 is a thin layer of acrylic resin or polycarbonate, for example. When light directly emitted from the light source 206 and light after being reflected pass through the diffusion plate 210, the diffusion plate 210 diffuses the light source uniformly to form a planar light.

A plurality of support elements 216 is also set up within the air gap 212 between the caved transparent plate 208 and the diffusion plate 210. The support elements 216 are fabricated using a transparent material with properties that affect the light distributing capability of the light source 206 as little as possible.

In addition, several optical film layers 214 are set up over the diffusion plate 210. The optical films 214 are light enhancing plates or prism plates, for example. The optical films 214 permits the passage of the planar light from the diffusion plate 210 into the liquid crystal panel (not shown) above the back light module 200 so that utilization efficiency of the light source 206 is increased.

With the additional setup of a caved transparent plate inside the back light module, thermal conduction is retarded by the gap between the caved transparent plate and the diffusion plate. When the amount of heat transferring to the liquid crystal panel is immensely reduced, a liquid crystal panel having a uniform display is produced.

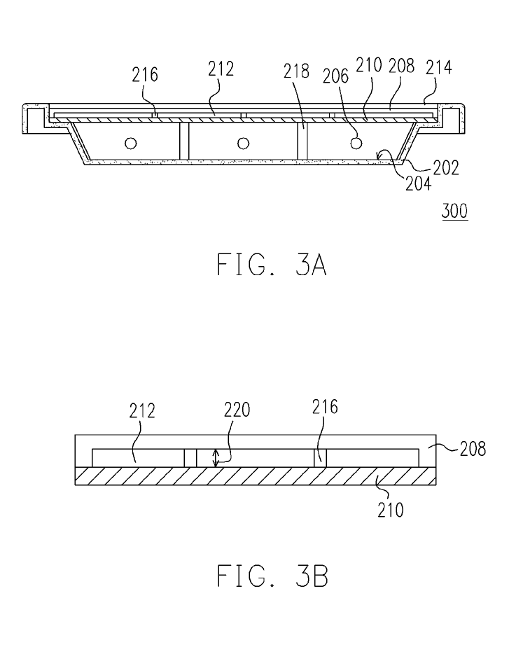

FIG. 3A is a schematic cross-sectional view of a back light module according to a second preferred embodiment of this invention. FIG. 3B is a magnified view of the diffusion plate and the caved transparent plate in the back light module shown in FIG. 3A. In the second embodiment, the caved transparent plate is set up over the diffusion plate. As shown in FIGS. 3A and 3B, the back light module 300 comprises a frame 202, a reflective plate 204, at least a light source 206, a diffusion plate 210, a caved transparent plate 208 and several optical films 214.

The reflective plate 204 is set up at a bottom section of the frame 202. The reflective plate 204 mainly serves as a reflective surface for deflecting light heading away from a display panel (not shown) so that the utilization efficiency of the light source 206 is increased. Furthermore, the reflective plate 204 is formed, for example, by roughening the inner surface of a white-coated plate or a resinous plate and then performing an aluminum surface treatment to increase the reflectivity of light.

The light source 206 is set up within the frame 202 above the reflective plate 204. The light source 206 is a lamp tube, a light bulb, a light-emitting diode array or a fluorescent lamp, for example. Furthermore, the fluorescent lamp is a straight tube, a U-shaped tube or a flat fluorescent light source. The light source 206 is positioned inside the frame 202 through support posts (not shown), for example.

The diffusion plate 210 is set up over the frame 202 above the light source 206. The diffusion plate 210 is a thin layer of acrylic resin or polycarbonate, for example.

When light directly emitted from the light source 206 and light after being reflected pass through the diffusion plate 210, the diffusion plate 210 diffuses the light to form a planar light.

The caved transparent plate 208 is set up over the diffusion plate 210 such that a gap 212 is formed between the diffusion plate 210 and the caved transparent plate 208. The gap 212 has a vertical height 220 between 2 to 5 millimeters. The caved transparent plate 208 is fabricated using a transparent material such as acrylic. In general, the caved transparent plate 208 must be fabricated using a material having properties including a high transparency, low deformation, and low moisture absorption. In addition, the space within the gap is air-filled. The air inside the spatial gap serves as an insulator blocking the transfer of heat across the gap.

A plurality of support elements 216 is also set up within the air gap 212 between the caved transparent plate 208 and the diffusion plate 210. The support elements 216 are fabricated using a transparent material with properties that affect the light distributing capability of the light source 206 as little as possible.

In addition, several optical film layers 214 are set up over the caved transparent plate 208. The optical films 214 are light enhancing plates or prism plates, for example. The optical films 214 permits the passage of the planar light from the diffusion plate 210 into the liquid crystal panel (not shown) above the back light module 200 so that the utilization efficiency of the light source 206 is increased.

Furthermore, at least one support element 218 for strengthening the entire back light module may be installed between the reflective plate 204 and the caved transparent plate 208 (as shown in FIG. 2) or between the reflective plate 204 and the diffusion plate (as shown in FIG. 3). The support element 218 is preferably fabricated using a transparent material having as little effect on the light-emitting properties of the light source 206 as possible.

Note that a liquid crystal panel (not shown) is set up over the aforementioned back light module (200 or 300) to form a fully functional liquid crystal display panel. The liquid crystal panel is a common active matrix liquid crystal display comprising a thin film transistor (TFT) array, a color filtering substrate and a liquid crystal layer. In general, the liquid crystal panel is set up over the optical films 214 above the frame 202. An additional frame (not shown) is also set up to cover the edges of the liquid crystal panel and fix the panel firmly onto the frame 202. The liquid crystal panel is fixed in position, for example, by pressing the frame at the edges of the panel against the frame 202 and locking the frame to the frame 202 using a set of screws. This completes the assembly of the liquid crystal display.

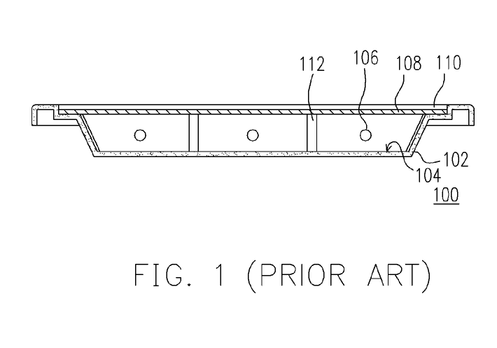

Accordingly, this invention utilizes an additional caved transparent plate with high transparency, low deformability and low moisture absorption properties between the fame and the diffusion plate (as shown in FIG. 1) or between the diffusion plate and the optical films (as shown in FIG. 2) to produce a heat barrier. Thus, heat from the light source is prevented from passing into the liquid crystal panel to affect the display quality. In addition, the air gap between the caved transparent plate and the diffusion plate is also utilized to block thermal conduction so that heat is prevented from passing into the liquid crystal panel above the back light module. Moreover, the caved transparent plate can be fabricated using an acrylic material. Since acrylic is not a costly material, the addition of an acrylic plate to the back light module incurs very little additional cost.

Note that the application of the back light module according to this invention is not limited to a liquid crystal display. The invention can also be applied to other types of display devices that require a back light module.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A back light module, comprising:
a frame;
a reflective plate set up at a bottom section of the frame;
at least a light source set up within the frame, wherein the light source is positioned above the reflective plate;
a caved transparent plate set up over the frame, wherein the caved transparent plate is positioned above the light source;
a diffusion plate set up over the caved transparent plate, wherein a gap is formed between the diffusion plate and the caved transparent plate; and
a plurality of optical films set up over the diffusion plate.

2. The back light module of claim 1, wherein the gap from the diffusion plate to the caved transparent plate has a height between 2 to 5 millimeters.

3. The back light module of claim 1, wherein material constituting the caved transparent plate comprises a transparent acrylic material.

4. The back light module of claim 1, wherein the module further comprises a plurality of support elements set up between the caved transparent plate and the diffusion plate.

5. The back light module of claim 1, wherein the light source comprises at least a lamp tube or a light-emitting diode.

6. The back light module of claim 1, wherein the optical films comprise light enhancing plates or prism plates.

7. A back light module, comprising:
a frame;
a reflective plate set up at a bottom section of the frame;
at least a light source set up within the frame, wherein the light source is positioned above the reflective plate;
a diffusion plate set up over the frame, wherein the diffusion plate is positioned above the light source;
a caved transparent plate set up over the diffusion plate, wherein a gap is formed between the caved transparent plate and the diffusion plate; and
a plurality of optical films set up over the diffusion plate.

8. The back light module of claim 7, wherein the gap from the diffusion plate to the caved transparent plate has a height between 2 to 5 millimeters.

9. The back light module of claim 7, wherein a material constituting the caved transparent plate comprises a transparent acrylic material.

10. The back light module of claim 7, wherein the module further comprises a plurality of support elements set up between the caved transparent plate and the diffusion plate.

11. The back light module of claim 7, wherein the light source comprises at least a lamp tube or a light-emitting diode.

12. The back light module of claim 7, wherein the optical films comprise light enhancing plates or prism plates.
